(19) United States
(12) Patent Application Publication
(10) Pub. No.: US 2011/0302187 A1
(43) Pub. Date: Dec. 8, 2011

(54) Schema definition generating device and schema definition generating method

(75) Inventors: Hiroshi Otsuka, Kawasaki (JP); Yasuhide Matsumoto, Kawasaki (JP); Yuji Wada, Kawasaki (JP); Shinya Kitajima, Kawasaki (JP); Masazumi Matsubara, Kawasaki (JP)

(73) Assignee: FUJITSU LIMITED, Kawasaki (JP)

(21) Appl. No.: 13/064,442

(22) Filed: Mar. 24, 2011

(30) Foreign Application Priority Data
Jun. 4, 2010 (JP) 2010-129441

(51) Int. Cl. G06F 17/30

(52) U.S. Cl. 707/768; 707/E17.045; 707/E17.014

(57) ABSTRACT

A schema definition generating device includes an item comparison generating unit that compares configuration item information and table information, and generates correspondence information indicating a correspondence between the configuration item information contained in a query formula used to search for configuration item information indicating a configuration item targeted for management and the table information contained in history information of queries made to a relational database; a relationship comparison generating unit that compares relational information and information indicating a relationship between tables contained in the query history information, and generates correspondence information indicating a correspondence between the relational information indicating a relationship between configuration items contained in the query formula and the query history information; and a schema definition generating unit that generates a schema definition of the configuration item information and a schema definition of the relational information by using the generated correspondence information.

### CROSS-REFERENCE TO RELATED APPLICATIONS

This application is based upon and claims the benefit of priority of the prior Japanese Patent Application No. 2010-129441, filed on Jun. 4, 2010, the entire contents of which are incorporated herein by reference.

### FIELD

The embodiments discussed herein are directed to a schema definition generating device and a schema definition generating method.

### BACKGROUND

An information management system recently known for information management in the case of linkage of a plurality of business systems or in an environment of multi-vendor operations management includes an FCMDB (federated configuration management database) that virtually integrates information of different systems.

As exemplified in FIG. 33, for example, an FCMDB manages data stored in a configuration information management system, and data in a maintenance contract information management system that are virtually integrated. The FCMDB manages data described in a plurality of schemas, thereby virtually integrating data stored in a plurality of systems.

Accordingly, a schema definition responsive to an object of an information management system is manually generated. More specifically, in order to generate a schema definition, an item to be managed by an FCMDB is set as a CI or a Relationship, information required for integration is selected. An administrator thereafter manually generates a schema definition of the FCMDB.

Patent Document: Japanese National Publication of International Application No. 2001-518670

In the aforementioned way of manually generating a schema definition, a process should be repeated for a plurality of systems, and required information should be selected manually. Thus, a large number of man-hours are required for generating a schema definition, and accordingly, a schema definition cannot be generated promptly.

### SUMMARY

According to an aspect of an embodiment of the invention, a schema definition generating device includes an item comparison generating unit that compares configuration item information and table information, and generates correspondence information indicating a correspondence between the configuration item information and the table information, the configuration item information being contained in a query formula used to search for configuration item information indicating a configuration item targeted for management, the table information being contained in history information of queries made to a relational database; a relationship comparison generating unit that compares relational information and information indicating a relationship between tables contained in the query history information, and generates correspondence information indicating a correspondence between the relational information and the query history information, the relational information indicating a relationship between configuration items contained in the query formula; and a schema definition generating unit that generates a schema definition of the configuration item information and a schema definition of the relational information by using the correspondence information generated by the item comparison generating unit, and the correspondence information generated by the relationship comparison generating unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating the structure of a schema generating device according to a first embodiment;

FIG. 2 is a block diagram illustrating the structure of a schema generating device according to a second embodiment;

FIG. 3 illustrates an example of a query formula;

FIG. 4 illustrates an SQL log;

FIG. 5 illustrates an example of a CI name list;

FIG. 6 illustrates an example of a table name list;

FIG. 7 illustrates an example of a CI candidate list;

FIG. 8 illustrates an example of a Relationship candidate list;

FIG. 9 explains a process of generating a correspondence between a CI and a table;

FIG. 10 explains a process of creating a dictionary across tables in different schemas;

FIG. 11 explains a process of creating a correspondence between a Relationship and an SQL sentence;

FIG. 12 explains a process of generating a schema;

FIG. 13 is a flow chart for explaining how the schema generating device according to the second embodiment operates in an entire process;

FIG. 14 is a flow chart for explaining how the schema generating device according to the second embodiment operates in a CI matching process;

FIG. 15 is a flow chart for explaining how the schema generating device according to the second embodiment operates in a Relationship matching process;

FIG. 16 is a flow chart for explaining how the schema generating device according to the second embodiment operates in a schema generation process;

FIG. 17 illustrates the structure of a schema generating device according to a third embodiment;

FIG. 18 illustrates an example of an unallocated table list;

FIG. 19 illustrates an example of a reconciliation candidate list;

FIG. 20 illustrates an example of a CI/Relationship list;

FIG. 21 illustrates an example of an unallocated CI list;

FIG. 22 illustrates an example of a pattern list;

FIG. 23 explains a process of assuming a target with which a table not related to any CI names is to be reconciled;

FIG. 24 explains verification to determine if an assumed model can be traced according to a query formula;

FIG. 25 explains a re-verification process performed when verification ends in failure;

FIG. 26 explains the details of the re-verification process performed when verification ends in failure;

FIG. 27 explains a process of generating a schema;

FIG. 28 is a flow chart for explaining how the schema generating device according to the third embodiment operates in an entire process;

FIG. 29 is a flow chart for explaining how the schema generating device, according to the third embodiment operates in a CI merge process;

FIG. 30 is a flow chart for explaining how the schema generating device according to the third embodiment operates in a verification process;

FIG. 31 is a flow chart for explaining how the schema generating device according to the third embodiment operates in a pattern changing process;

FIG. 32 illustrates a computer that executes a schema generating program; and

FIG. 33 explains the structure of a data center.

### DESCRIPTION OF EMBODIMENT(S)

Preferred embodiments of the present invention will be explained with reference to accompanying drawings. The invention is not to be limited by the embodiment(s).

### [a] First Embodiment

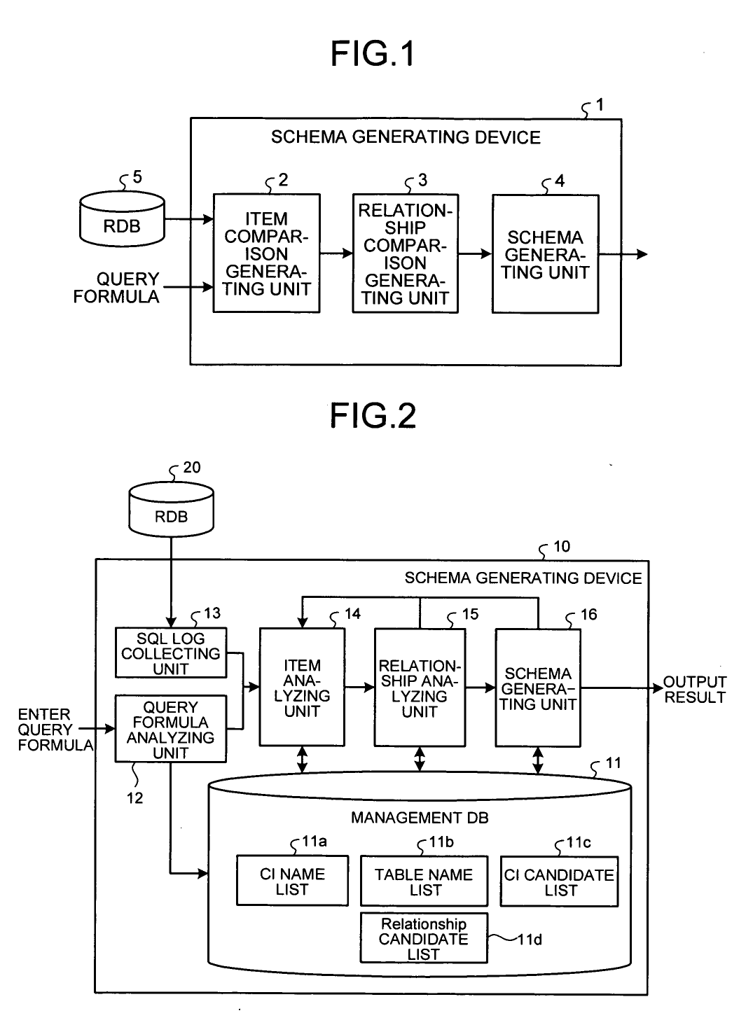

The structure of a schema generating device according to a first embodiment is described first by using FIG. 1. FIG. 1 is a block diagram illustrating the structure of the schema generating device according to the first embodiment.

A schema generating device 1 according to the first embodiment includes an item comparison generating unit 2, a relationship comparison generating unit 3, and a schema generating unit 4, which are connected to a relational database 5 (represented as “RDB” in FIG. 1). The schema generating device 1 accepts the entry of a query formula to search for configuration item information indicating a configuration item to be managed, and collects query history information from the relational database 5.

The item comparison generating unit 2 compares configuration item information contained in a query formula used to search for configuration item information indicating a configuration item targeted for management, and table information contained in history information of queries made to the relational database 5. Then, the item comparison generating unit 2 generates correspondence information indicating a correspondence between the configuration item information and the table information.

The relationship comparison generating unit 3 compares relational information indicating a relationship between configuration items contained in the query formula, and information indicating a relationship between tables contained in the query history information. Then, the relationship comparison generating unit 3 generates correspondence information indicating a correspondence between the relational information and the query history information.

The schema generating unit 4 generates a schema definition of the configuration item information and a schema definition of the relational information by using the correspondence information generated by the item comparison generating unit 2, and the correspondence information generated by the relationship comparison generating unit 3.

As described above, in the schema generating device 1 of the first embodiment, a schema definition can be generated automatically by using existing information such as a query formula and query history information. As a result, the number of man-hours required for generating a schema can be reduced.

### [b] Second Embodiment

The structure of a schema generating device according to a second embodiment, and a flow of processes performed by the schema generating device according to the second embodiment will be described in this order. An effect achieved by the second embodiment will be described thereafter.

Structure of Schema Generating Device

The structure of a schema generating device 10 will be described first by using FIG. 2. FIG. 2 is a block diagram illustrating the structure of the schema generating device according to the second embodiment. As illustrated in FIG. 2, the schema generating device 10 includes a management DB 11, a query formula analyzing unit 12, an SQL log collecting unit 13, an item analyzing unit 14, a relationship analyzing unit 15, and a schema generating unit 16, which are connected to an RDB 20.

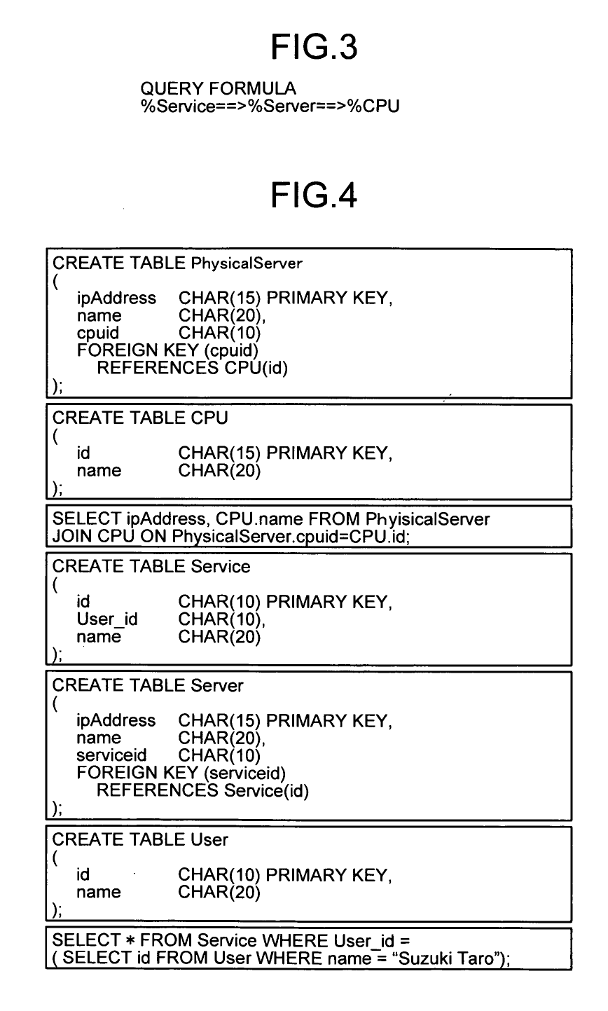

The schema generating device 10 accepts a query formula (such as that illustrated in FIG. 3 discussed in detail below) described in an Xpath (XML path language) extended for FCMDBs. Further, the schema generating device 10 collects an SQL log (such as that illustrated in FIG. 4 discussed in detail below) stored in the RDB 20. The query formula mentioned here is used to search for a CI, and which contains information about a CI and a Relationship, and the structures of the CI and the relationship. The SQL log is a history of queries made to a relational database. The SQL log contains information about tables, and a relationship between the tables.

A query formula extended for FCMDBs specifies the type of a CI or a Relationship the information of which is requested. As an example, a search query to search for information about a server, namely information about a CI with a CI type “Server” is expressed as “%Server”. Putting “%” before a name indicates that this name is a CI name.

Placing a CI and a Relationship alternately enables trace by following a relationship between CIs. As an example, a query formula to search for information about an administrator of a server is expressed as “%Server==>%User”, where “==>” means a Relationship.

Putting “*” after “%” enables search by specifying all CI types. As an example, a query formula expressed as “%Server==>%*” indicates that information about a CI having any relationship with the CI type “Server” is requested.

Inserting information for specifically designating a requested CI after a CI type enables detail search of the CI. As an example, a query formula to search for information about a server named A is expressed as “%Server[@name==‘A’]”.

The management DB 11 stores data necessary for various processes. The management DB 11 also stores a CI name list 11a, a table name list 11b, a CI candidate list 11c, and a Relationship candidate list 11d.

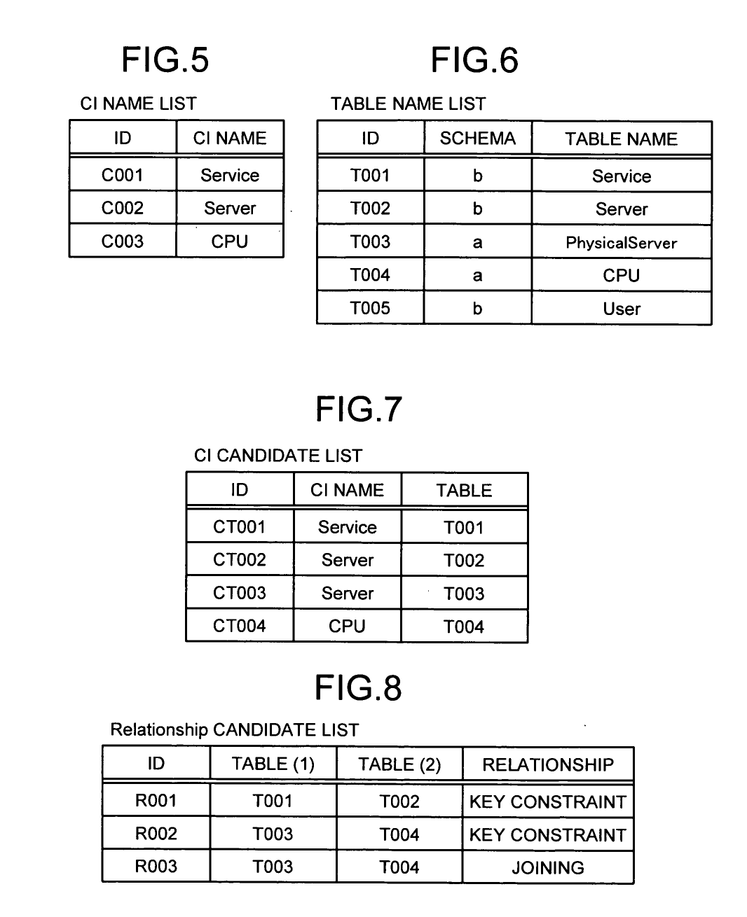

The CI name list 11a includes a CI name contained in a query formula. More specifically, as illustrated in FIG. 5, the CI name list 11a includes “ID” for uniquely identifying a CI name, and “CI NAME” contained in a query formula that are related to each other. To be more specific, as exemplified in FIG. 3, the CI name list 11a includes CI names “Service”, “Server”, and “CPU” that are contained in the query formula exemplified in FIG. 3.

The table name list 11b includes a table name contained in an SQL log. More specifically, as illustrated in FIG. 6, the table name list 11b includes “ID” for uniquely identifying a table name, “SCHEMA” indicating the schema type of a table, and “TABLE NAME” contained in an SQL log that are related to one another.

The CI candidate list 11c includes a CI name as a CI candidate that coincides with a table name stored in the table name list 11b. The CI name stored in the CI candidate list 11c is one of those stored in the CI name list 11a. More specifically, as illustrated in FIG. 7, the CI candidate list 11c includes “ID” for uniquely identifying a CI candidate, “CI NAME” illustrating the CI candidate, and “TABLE” illustrating the ID of a table name that coincides with the CI name.

The Relationship candidate list 11d includes a set of table names in the CI candidate list 11c that correspond to CIs placed before and after a Relationship name in a query formula. More specifically, as illustrated in FIG. 8, the Relationship candidate list 11d includes “ID” for uniquely identifying a Relationship candidate, “TABLE (1)” and “TABLE (2)” indicating table names in a set corresponding to CIs placed before and after a Relationship name, and “RELATIONSHIP” indicating a relationship in an SQL sentence between the table names in a set. In the Relationship candidate list 11d, “ID”, “TABLE (1)” and “TABLE (2)”, and “RELATIONSHIP” are related to one another.

A relationship in the SQL between table names in a set will be described next by using the exemplary SQL log illustrated in FIG. 4. A specific SQL sentence in the SQL log (such as subquery, joining, key constraint, and others) is used to specify a relationship in the SQL between table names in a set. As exemplified in FIG. 4, for example, a table name “server” includes “FOREIGN KEY (serviceid)” indicating key constraint. In this case, a relationship between table names “service” and “Server” is considered as “key constraint”. Then, the relationship and the table names are entered into the Relationship candidate list 11d.

Referring to the SQL log illustrated in FIG. 4, a table name “PhysicalServer” includes “JOIN CPU ON” indicating joining. In this case, a relationship between table names “PhysicalServer” and “CPU” is considered as “joining”. Then, the relationship and the table names are entered into the relationship candidate list 11d.

The query formula analyzing unit 12 analyzes a query formula described in the extended Xpath (XML path language) to create the CI name list 11a. More specifically, when accepting a query formula such as that illustrated in FIG. 3, the query formula analyzing unit 12 divides the query formula to create the CI name list 11a, and stores the created CI name list 11a into the management DB 11. As an example, when accepting the query formula exemplified in FIG. 3, the query formula analyzing unit 12 divides the query formula into “Service”, “Server”, and “CPU”. Then, the query formula analyzing unit 12 enters CI names “Service”, “Server”, and “CPU” into the CI name list 11a in the management DB 11.

The SQL log collecting unit 13 collects an SQL log from the RDB 20. More specifically, the SQL log collecting unit 13 collects an SQL log from the RDB 20, creates the table name list 11b, and stores the created table name list 11b into the management DB 11. As an example, if collecting the SQL log exemplified in FIG. 4, the SQL log collecting unit 13 enters table names “Service”, “Server”, “PhysicalServer”, “CPU”, and “User” into the table name list 11b in the management DB 11.

The item analyzing unit 14 compares CI information contained in a query formula to search for a CI, and table information contained in an SQL log into the relational database 20. Then, the item analyzing unit 14 creates the CI candidate list 11c indicating a correspondence between the configuration item information and the table information. More specifically, the item analyzing unit 14 retrieves one CI name from the CI name list 11a, and acquires one table name from the table name list 11b.

Then, the item analyzing unit 14 compares the CI name and the table name by using a group of comparison functions (including complete comparison and partial comparison) to determine if the CI name and the table name coincide with each other. If the CI name and the table name coincide, the item analyzing unit 14 generates a correspondence, and enters the correspondence into the CI candidate list 11c.

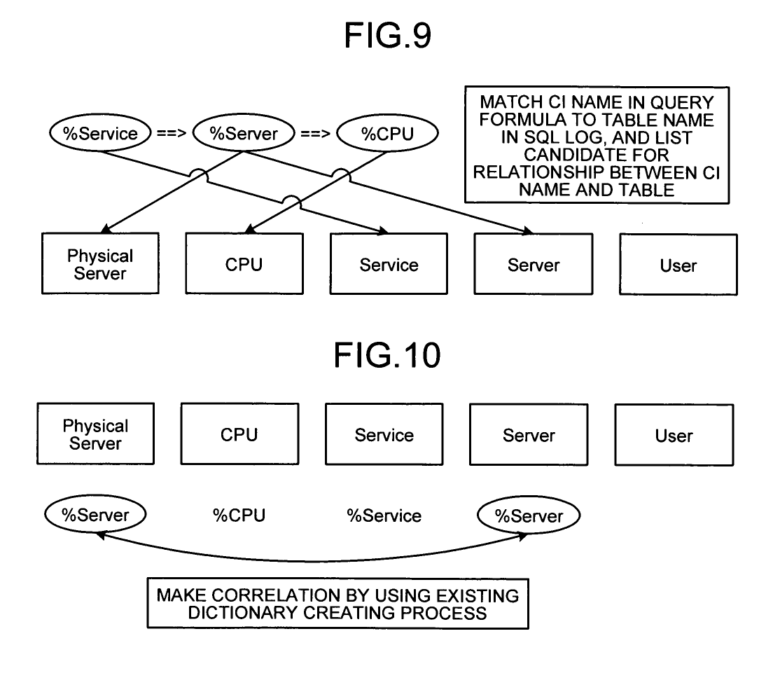

A process of generating a correspondence between a CI and a table will be described next by using FIG. 9. FIG. 9 explains a process of generating a correspondence between a CI and a table. As illustrated in FIG. 9, the item analyzing unit 14 matches CI names in a query formula to table names in an SQL log, lists a candidate for a relationship between a CI and a table, and enters the candidate into the CI candidate list 11c.

The item analyzing unit 14 acquires one CI from the CI name list 11a after making comparison of all table names. If the CI candidate list 11c includes a plurality of CI names that correspond to the acquired CI, the item analyzing unit 14 may create a dictionary in which a correspondence between the same CI names is stored.

A process of creating a dictionary across tables in different schemas is explained by using FIG. 10. As exemplified in FIG. 10, for example, if a plurality of CI names “Server” exist in the CI candidate list 11c, and tables in different schemas are allocated to these CI names, the item analyzing unit 14 uses an existing dictionary creating process to generate dictionary information in which the CI names “Server” are correlated.

The relationship analyzing unit 15 compares a Relationship contained in a query formula, and a specific SQL sentence indicating a relationship between tables contained in an SQL log. Then, the relationship analyzing unit 15 creates the Relationship candidate list 11d indicating a correspondence between the Relationship and the SQL. More specifically, the relationship analyzing unit 15 retrieves one Relationship from a query formula, and retrieves table names corresponding to CIs placed before and after the Relationship from the CI candidate list 11c.

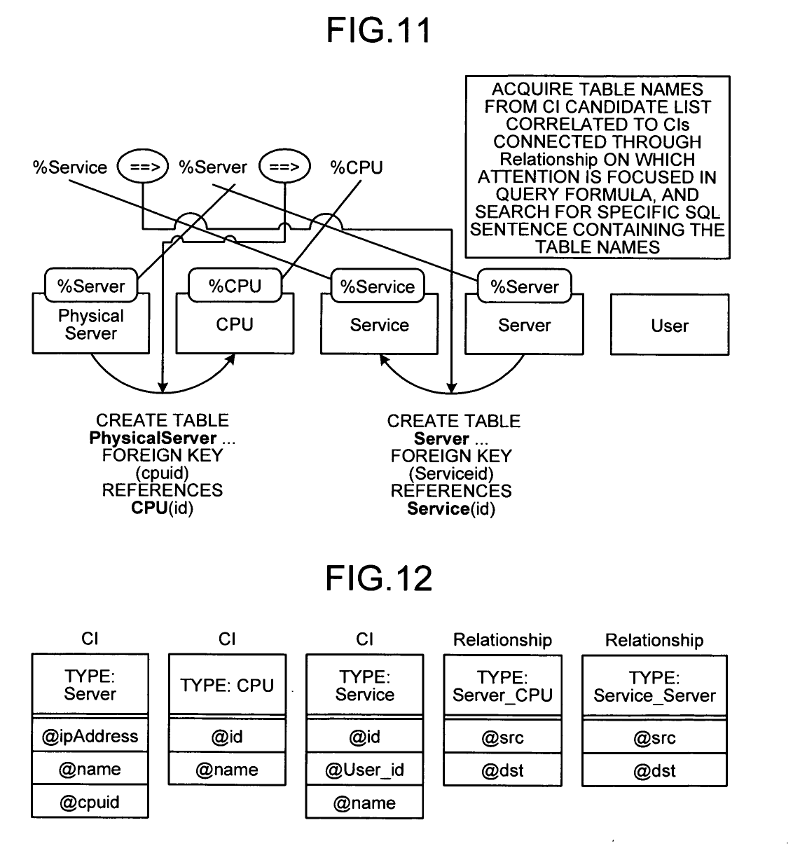

Then, the relationship analyzing unit 15 lists a relationship in the SQL log, and enters the presence or absence, and the type of a relationship thereof with a corresponding Relationship into the Relationship candidate list 11d. A process of creating a correspondence between a Relationship and an SQL sentence will be described by using FIG. 11. FIG. 11 explains a process of creating a correspondence between a Relationship and an SQL sentence. As illustrated in FIG. 11, the relationship analyzing unit 15 acquires tables from the CI candidate list 11c that are correlated to CIs connected through a Relationship on which attention is focused in a query formula. Then, the relationship analyzing unit 15 searches for a specific SQL containing the names of the tables.

As exemplified in FIG. 11, for example, if attention is focused on a Relationship indicating a relationship between CI names “Service” and “Server”, the relationship analyzing unit 15 searches for a specific SQL sentence containing table names “Service” and “PhysicalServer” correlated to the CI names “Service” and “Server”, respectively. As a result, the relationship analyzing unit 15 acquires “CREATE TABLE PhysicalServer . . . FOREIGN KEY (cpuid) REFERENCES CPU (id)”.

The acquired sentence contains “FOREIGN KEY” indicating key constraint. Accordingly, the relationship analyzing unit 15 enters the type of a relationship “key constraint” into the Relationship candidate list 11d.

The schema generating unit 16 generates a schema definition of a CI and a schema definition of a Relationship by using the CI candidate list 11c and the Relationship candidate list 11d. More specifically, the schema generating unit 16 retrieves one from the CI name list 11a, and retrieves a table name from the CI candidate list 11c and the table name list 11b.

Next, the schema generating unit 16 searches an SQL log to acquire an attribute name contained therein, and then generates a CI definition based on the table name and the acquired attribute name. After generating CI definitions of all CIs, the schema generating unit 16 retrieves one from the Relationship candidate list 11d, and generates a Relationship definition by referring to the CI candidate list 11c.

The schema generating unit 16 thereafter repeats the process of generating a Relationship definition until Relationship definitions are generated for all Relationship candidates. As exemplified in FIG. 12, for example, the schema generating unit 16 generates a CI definition and a Relationship definition as a schema to be generated.

In the example illustrated in FIG. 12, the schema generating unit 16 generates CI definitions of CI types “Server”, “CPU”, and “Service”. The schema generating unit 16 also generates Relationship definitions of Relationship types “Server-CPU” and “Service-Server”.

It is assumed, for example, that the schema generating unit 16 generates a CI definition of a CI type “Service” in “TABLE Service” in the SQL log illustrated in FIG. 4. “TABLE Service” in the SQL log exemplified in FIG. 4 includes “id” indicating a service ID, “user_id” indicating a user ID, and “name” indicating a service name that are listed as column names. The schema generating unit 16 generates “id”, “user_id”, and “Service” as CI definitions by using these column names.

As another example, as a Relationship definition of Relationship type “CPU”, the schema generating unit 16 defines “src” as an attribute name indicating a CI as a source of connection, and “dst” as an attribute name indicating a CI as a target of connection.

As described above, a schema definition can be generated automatically by using information that can be prepared easily such as a query formula, an SQL log, and the like. As a result, the number of man-hours required for generating a schema definition can be reduced, so that a schema definition can be generated promptly.

Process by Schema Generating Device

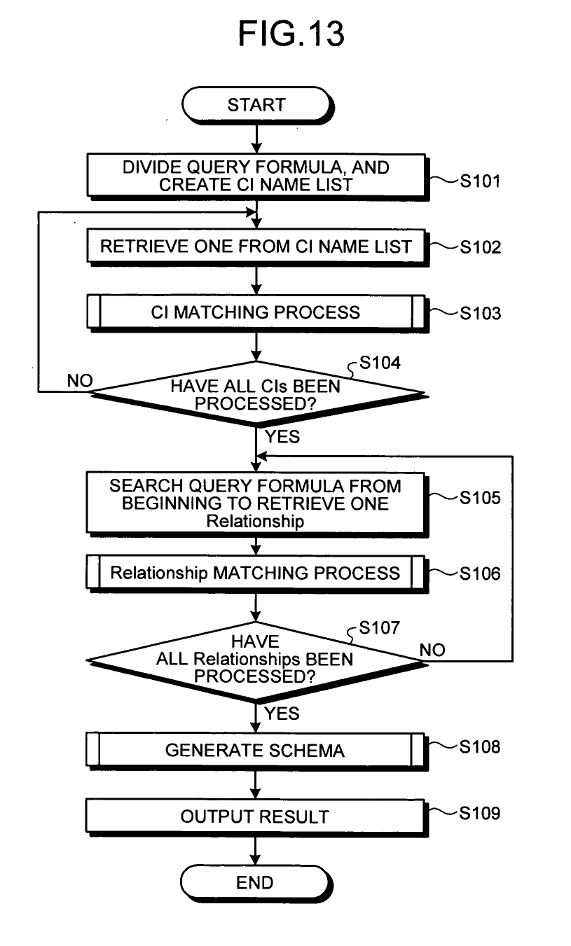

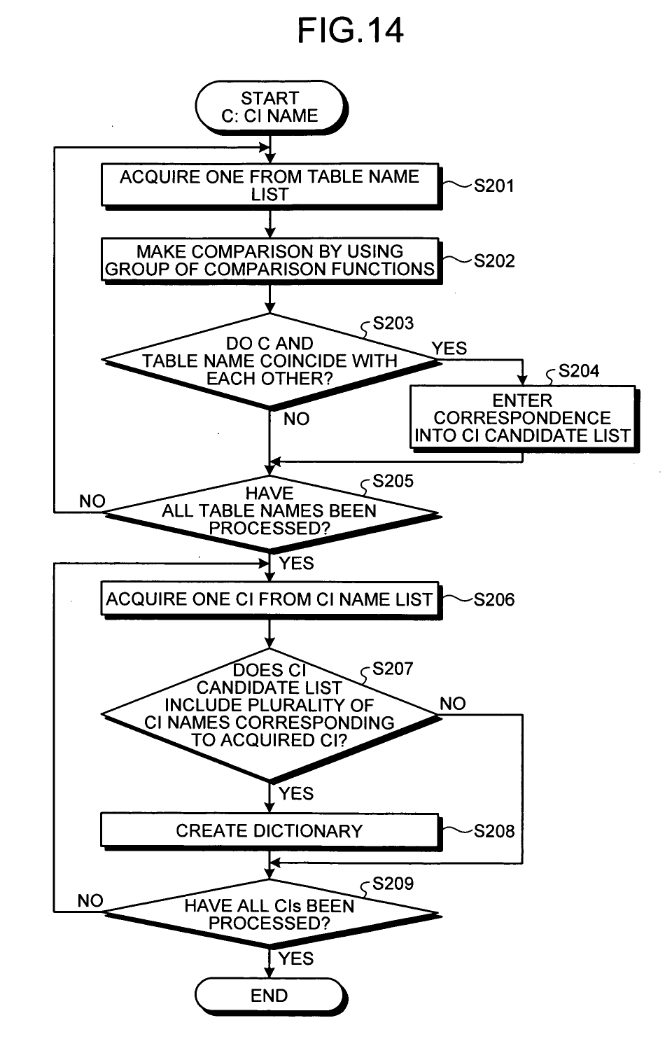

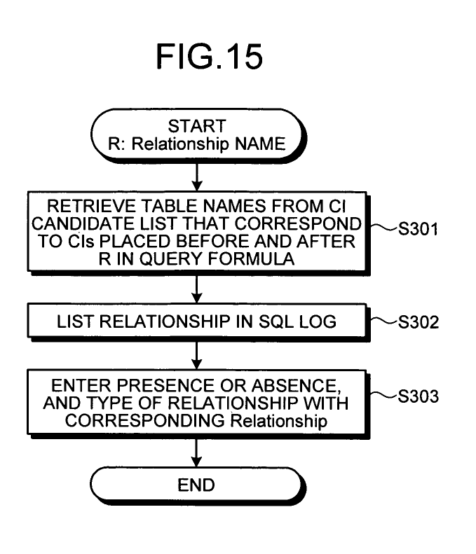

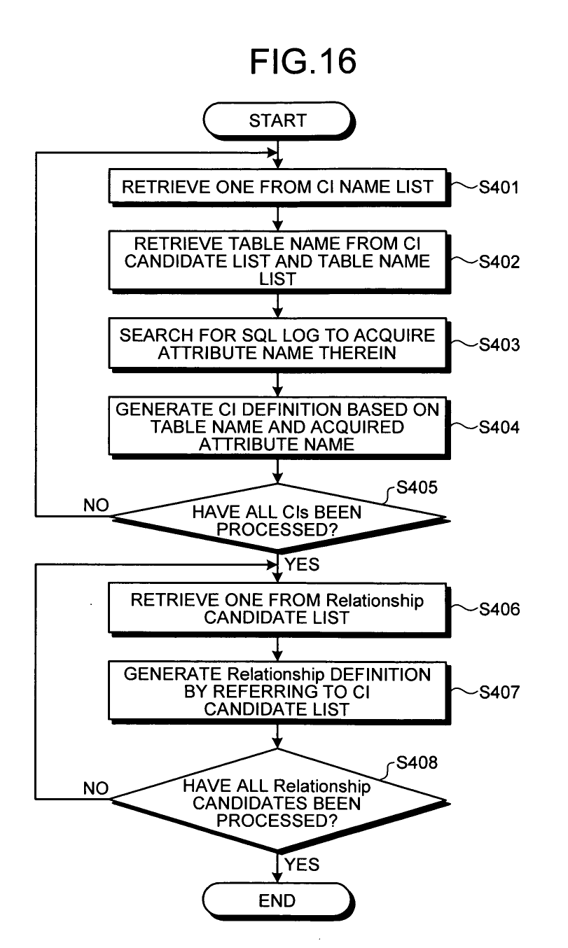

Processes by the schema generating device 10 according to the second embodiment will next be explained by using FIGS. 13 to 16. FIG. 13 is a flow chart for explaining how the schema generating device 10 according to the second embodiment operates in its process. FIG. 14 is a flow chart for explaining how the schema generating device according to the second embodiment operates in a CI matching process. FIG. 15 is a flow chart for explaining how the schema generating device according to the second embodiment operates in a Relationship matching process. FIG. 16 is a flow chart for explaining how the schema generating device according to the second embodiment operates in a schema generation process.

As illustrated in FIG. 13, when accepting a query formula described in the extended Xpath, the schema generating device 10 divides the query formula, and creates the CI name list 11a (step S101). Then, the schema generating device 10 retrieves one CI name from the CI name list 11a (step S102), and performs the CI matching process (step S103) (described in detail later by using FIG. 14).

Next, the schema generating device 10 determines if all CIs have been processed (step S104). If all CIs have not been processed (No in step S104), the schema generating device 10 returns to step S102 to repeat the process.

If all CIs have been processed (Yes in step S104), the schema generating device 10 searches the query formula from the beginning to retrieve one Relationship (step S105), and performs the Relationship matching process (step S106) (described in detail later by using FIG. 15).

The schema generating device 10 thereafter determines if all Relationships have been processed (step S107). If all Relationships have not been processed (No in step S107), the schema generating device 10 returns to step S105 to repeat the process. If all Relationships have been processed (Yes in step S107), the schema generating device 10 performs the schema generating process (step S108) (described in detail later by using FIG. 16), and outputs a generated schema as a result (step S109).

The CI matching process will be described by using FIG. 14. As illustrated in FIG. 14, the item analyzing unit 14 of the schema generating device 10 acquires one table name from the table name list 11b (step S201). Next, the item analyzing unit 14 compares the CI name and the table name by using a group of comparison functions (step S202) to determine if the CI name and the table name coincide with each other (step S203). If the CI name and the table name coincide (Yes in step S203), the item analyzing unit 14 enters a correspondence into the CI candidate list 11c (step S204).

The item analyzing unit 14 thereafter determines if all table names have been subjected to the comparison (step S205). If all table names have not been subjected to the comparison (No in step S205), the item analyzing unit 14 returns to step S201 to repeat the process. If all table names have been subjected to the comparison (Yes in step S205), the item analyzing unit 14 acquires one CI from the CI name list 11a (step S206), and determines if the CI candidate list 11c includes a plurality of CI names that correspond to the acquired CI (step S207).

If the CI candidate list 11c includes a plurality of CI names corresponding to the acquired CI (Yes in step S207), the item analyzing unit 14 creates a dictionary in which a plurality of CI names are correlated (step S208). Next, the item analyzing unit 14 determines if all CIs have been processed (step S209). If all CIs have not been processed (No in step S209), the item analyzing unit 14 returns to step S206 to repeat the process. If all CIs have been processed (Yes in step S209), the item analyzing unit 14 finishes the CI matching process.

The Relationship matching process will now be described by using FIG. 15. As illustrated in FIG. 15, table names corresponding to CIs placed before and after a Relationship are retrieved from the CI candidate list 11c.

As illustrated in FIG. 15, the relationship analyzing unit 15 of the schema generating device 10 retrieves table names from the CI candidate list 11c that correspond to CIs placed before and after a Relationship in the query formula (step S301). Then, the schema generating device 10 lists a Relationship in an SQL log (step S302), and enters the presence or absence, and the type of a relationship thereof with a corresponding Relationship into the Relationship candidate list 11d (step S303).

The schema generating process will be described next by using FIG. 16. As illustrated in FIG. 16, the schema generating unit 16 of the schema generating device 10 retrieves one from the CI name list 11a (step S401), and retrieves a table name from the CI candidate list 11c and the table name list 11b (step S402).

Next, the schema generating unit 16 searches the SQL log to acquire an attribute name contained therein (step S403), and then generates a CI definition based on the table name and the acquired attribute name (step S404). The schema generating unit 16 thereafter determines if all CIs have been processed (step S405). If all CIs have not been processed (No in step S405), the schema generating unit 16 returns to step S401 to repeat the process.

If all CIs have been processed (Yes in step S405), the schema generating unit 16 retrieves one from the Relationship candidate list 11d (step S406), and generates a Relationship definition by referring to the CI candidate list 11c (step S407).

The schema generating unit 16 thereafter determines if Relationship definitions of all relationship candidates have been generated (step S408). If Relationship definitions of all Relationship candidates have not been generated (No in step S408), the schema generating unit 16 returns to step S406. If Relationship definitions of all Relationship candidates have been generated (Yes in step S408), the schema generating unit 16 finishes the schema generating process.

Effect of Second Embodiment

As described above, the schema generating device 10 compares CI information contained in a query formula to search for a CI, and table information contained in an SQL log into the relational database 20. Then, the schema generating device 10 creates the CI candidate list 11c indicating a correspondence between the configuration item information and the table information. The schema generating device 10 also compares a Relationship contained in the query formula, and a specific SQL sentence indicating a relationship between tables contained in the SQL log. Then, the schema generating device 10 creates the Relationship candidate list 11d indicating a correspondence between the Relationship and the SQL. The schema generating device 10 thereafter generates a schema definition of a CI and a schema definition of a Relationship by using the CI candidate list 11c and the Relationship candidate list 11d. Thus, a schema definition can be generated automatically. As a result, the number of man-hours required for generating a schema definition can be reduced, so that a schema definition can be generated promptly.

In the second embodiment, the name of CI information contained in a query formula and the name of table information contained in an SQL log are compared. Then, the name of the configuration item information and the name of the table information are defined in a set as the aforementioned correspondence information if the name of the configuration item information and the name of the table information coincide with each other. Thus, a schema definition can be generated automatically by using information that can be prepared easily such as a query formula and an SQL log. As a result, the number of man-hours required for generating a schema definition can be reduced, so that a schema definition can be generated promptly.

### [c] Third Embodiment

In the second embodiment described above, the schema generating process is performed after the CI matching process and the Relationship matching process are performed, to which the invention is not limited. By way of example, a CI merge process for assuming a target of reconciliation, and a verification process for determining if a CI and a Relationship can be followed according to a query formula, may be performed after the CI matching process and the relationship matching process are performed.

In a third embodiment, a CI merge process and a verification process are performed after the CI matching process and the Relationship matching process are performed. The structure and processes of a schema generating device 10A of the third embodiment will be described below.

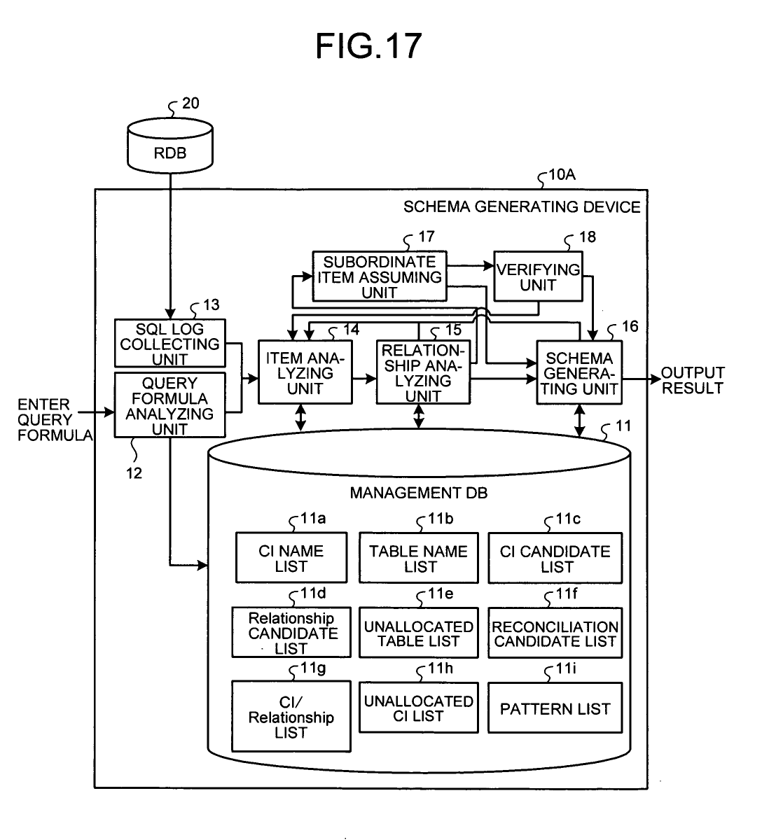

The structure of the schema generating device 10A will first be described by using FIG. 17. As illustrated in FIG. 17, the schema generating device 10A differs from the schema generating device 10 illustrated in FIG. 2 in that the schema generating device 10A additionally includes an unallocated table list 11e, a reconciliation candidate list 11f, a CI/Relationship list 11g, an unallocated CI list 11h, a pattern list 11i, a subordinate item assuming unit 17, and a verifying unit 18.

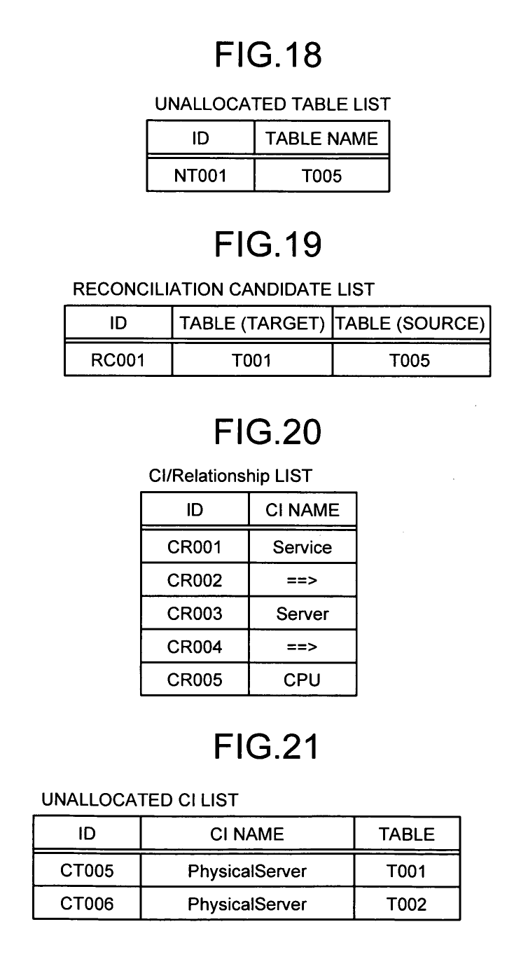

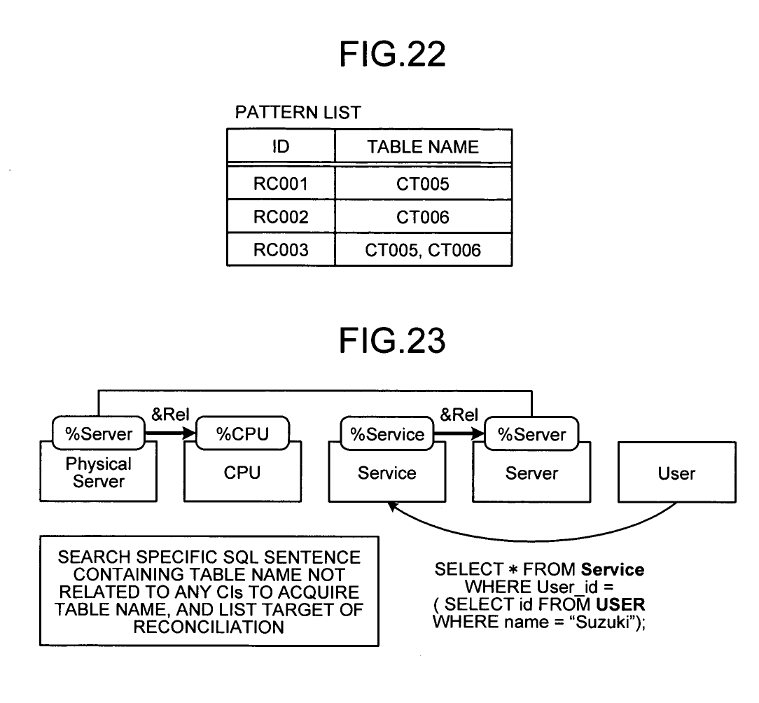

The unallocated table list 11e includes a table name that is not related to any CIs. More specifically, as illustrated in FIG. 18, the unallocated table list 11e includes “ID” for uniquely identifying a table that is not related to any CIs, and “TABLE NAME” indicating the ID of the table that is not related to any CIs. In the unallocated table list 11e, “ID” and “TABLE NAME” are related to each other.

The reconciliation candidate list 11f includes a candidate for a target with which a table not related to any CIs is to be reconciled. More specifically, as illustrated in FIG. 19, the reconciliation candidate list 11f includes “ID” for uniquely identifying a candidate for a target of reconciliation, “TABLE (TARGET)” indicating a table as a target of reconciliation, and “TABLE (SOURCE)” indicating a table as a source of reconciliation. In the reconciliation candidate list 11f, “ID”, “TABLE (TARGET)”, and “TABLE (SOURCE)” are related to one another.

The CI/Relationship list 11g includes a CI and a Relationship. More specifically, as illustrated in FIG. 20, the CI/Relationship list 11g includes “ID” for uniquely identifying a CI or a Relationship, and “CI/Rel” indicating if a type is a CI or a Relationship. In the CI/Relationship list 11g, “ID” and “CI/Rel” are related to each other.

The unallocated CI list 11h includes a CI that caused failure in verification. More specifically, as illustrated in FIG. 21, the unallocated CI list 11h includes “ID” for uniquely identifying a CI candidate having caused failure in verification, “CI NAME” indicating the name of the CI having caused the failure in verification, and “TABLE” for uniquely identifying a table corresponding to the CI having caused the failure in verification. In the unallocated CI list 11h, “ID”, “CI NAME”, and “TABLE” are related to one another.

The subordinate item assuming unit 17 analyzes an SQL sentence associated with a remaining table that is left without having been related to any CIs, and assumes a CI with which the remaining table is to be reconciled. More specifically, the subordinate item assuming unit 17 searches a specific SQL sentence containing a remaining table left without having being related to any CIs to acquire a table name contained in the SQL sentence, and then lists a target of reconciliation. The specific SQL sentence mentioned here means a subquery, joining, key constraint, and others.

By using the example illustrated in FIG. 23, if a table “User” is left without having been related to any CIs, the subordinate item assuming unit 17 searches a specific SQL sentence containing the table name “User”.

As a result of the search, the subordinate item assuming unit 17 acquires an SQL sentence “Select*FROM Service WHERE user_id=(SELECT id FROM User WHERE name=“Suzuki”);” from an SQL log. The acquired SQL sentence “Select*FROM Service WHERE user_id=(SELECT id FROM User WHERE name=“Suzuki”);” is a subquery containing the table name “User”.

Then, the subordinate item assuming unit 17 assumes that a different table name “Service” is a target of reconciliation that is contained in the SQL sentence “Select*FROM Service WHERE user_id=(SELECT id FROM User WHERE name=“Suzuki”);”. The subordinate item assuming unit 17 thereafter enters the remaining table that is left without having been related to any CIs, and the table assumed as a target of reconciliation into the reconciliation candidate list 11f, in a manner that the remaining table and the table assumed as a target of reconciliation are related to each other.

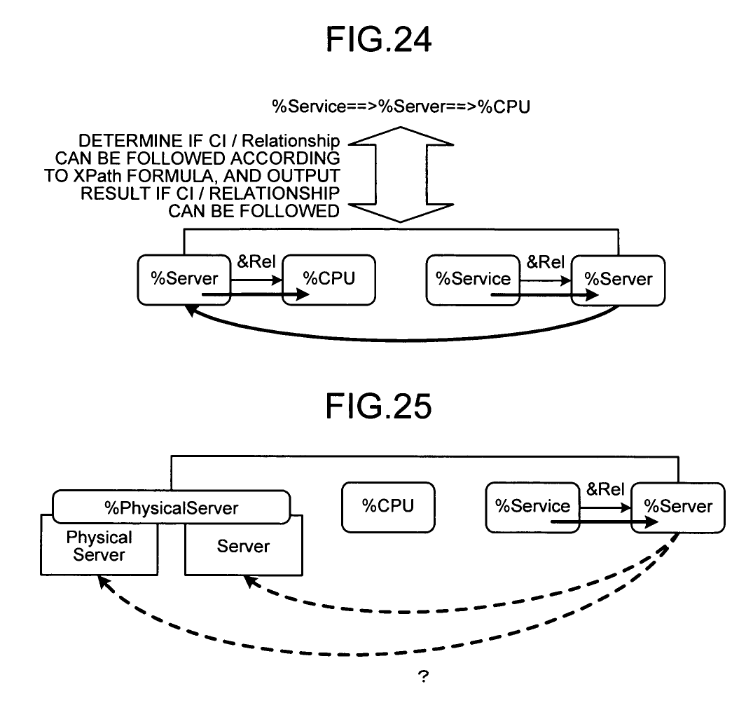

The verifying unit 18 determines if a CI and a Relationship can be followed according to a query formula. More specifically, the verifying unit 18 divides a query formula to create the CI/Relationship list 11g. Then, as illustrated in FIG. 24, the verifying unit 18 retrieves a CI or a Relationship one by one from the CI/Relationship list 11g to determine if the CI and the Relationship can be followed according to the query formula.

In the example illustrated in FIG. 24, the verifying unit 18 retrieves a CI and a Relationship one by one from the CI/Relationship list 11g when a query formula is “%Service==>%Server==>%CPU”. Then, the verifying unit 18 determines if a CI “Service”, a Relationship, a CI “Server”, a Relationship, and a CI “CPU” can be followed in this order.

Verification may end in failure. A description will be given of this case. As an example, the verifying unit 18 cannot follow a CI and a Relationship according to a query formula if determining as a result of verification that there is a plurality of corresponding Relationships, or if a CI to be followed is related to a plurality of tables.

In the example illustrated in FIG. 25, for example, a plurality of tables “PhysicalServer” and “Server” are related to a CI “PhysicalServer”, meaning that there is a plurality of Relationships. Accordingly, the verifying unit 18 cannot follow a CI and a Relationship according to a query formula.

If verification ends in failure, the verifying unit 18 enters a CI having caused failure in trace and a table corresponding to the CI into the unallocated CI list 11h. The verifying unit 18 also generates a conditional pattern according to which the number of associations between the CI having caused the failure in trace and the table is reduced, and enters the generated conditional pattern into the pattern list 11i. The verifying unit 18 repeats the verification process by adapting conditional patterns in turn until verification is performed successfully.

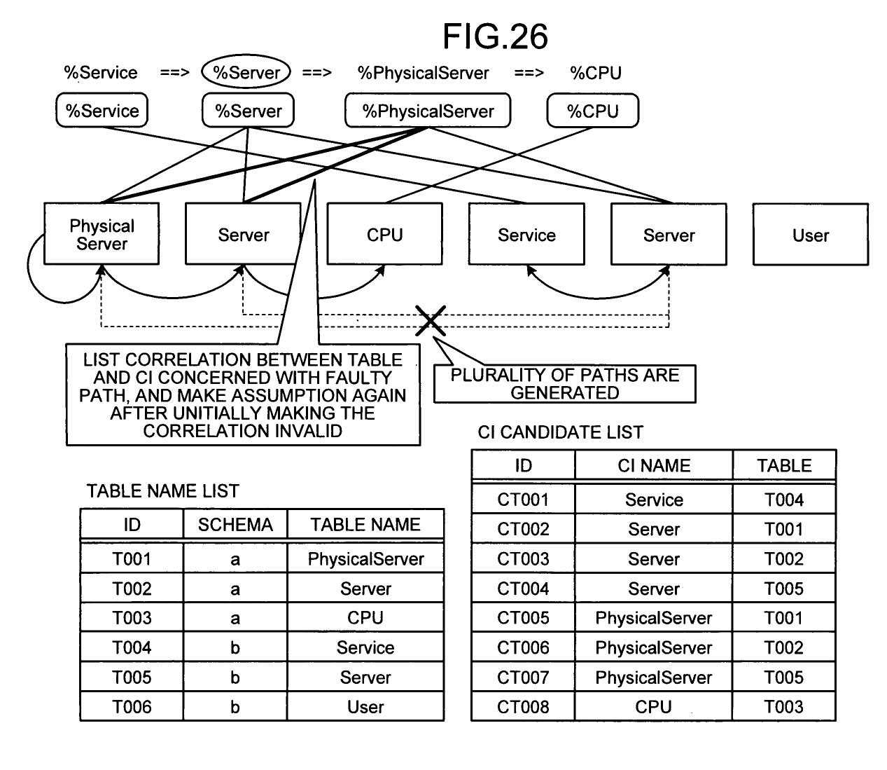

In the example illustrated in FIG. 26, as a result of verification of a query formula “%Service==>%Server==>%PhysicalServer==>%CPU”, the verifying unit 18 determines that a CI “Server” has a plurality of paths. In this case, the verification ends in failure. Accordingly, the verifying unit 18 enters information about the CI “Server” having caused the failure in trace into the unallocated CI list 11h.

The verifying unit 18 thereafter acquires table names “PhysicalServer”, “Server”, and “Server” related to the CI “Server” having caused the failure in trace from a CI candidate list. Then, the verifying unit 18 enters a pattern according to which a correspondence between a CI and a table is partially made invalid into the pattern list 11i. The verifying unit 18 retrieves patterns one by one, and repeats the verification process by adapting the retrieved patterns in turn until verification is performed successfully.

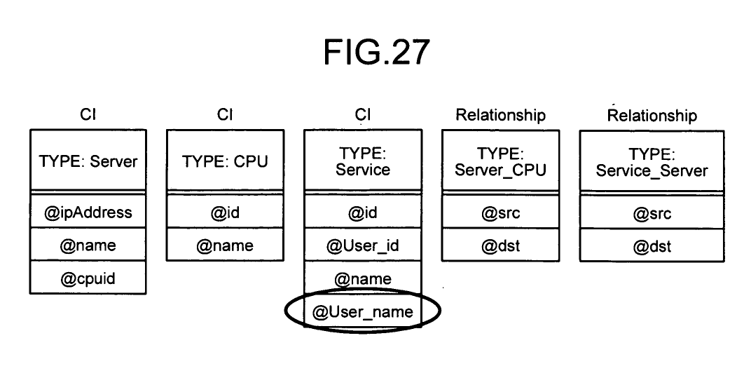

Like in the second embodiment, the schema generating unit 16 generates a schema definition of a CI and a schema definition of a Relationship. In the schema generating device 10A according to the third embodiment, the subordinate item assuming unit 17 assumes a CI with which a remaining table that is left without having been related to any CIs is to be reconciled. Thus, in the schema generating device 10A according to the third embodiment, information about a table that is left without having been related to any CIs is merged. Accordingly, compared to the schemas exemplified in FIG. 12, “@user_name” is added to a CI type “Service” as exemplified in FIG. 27.

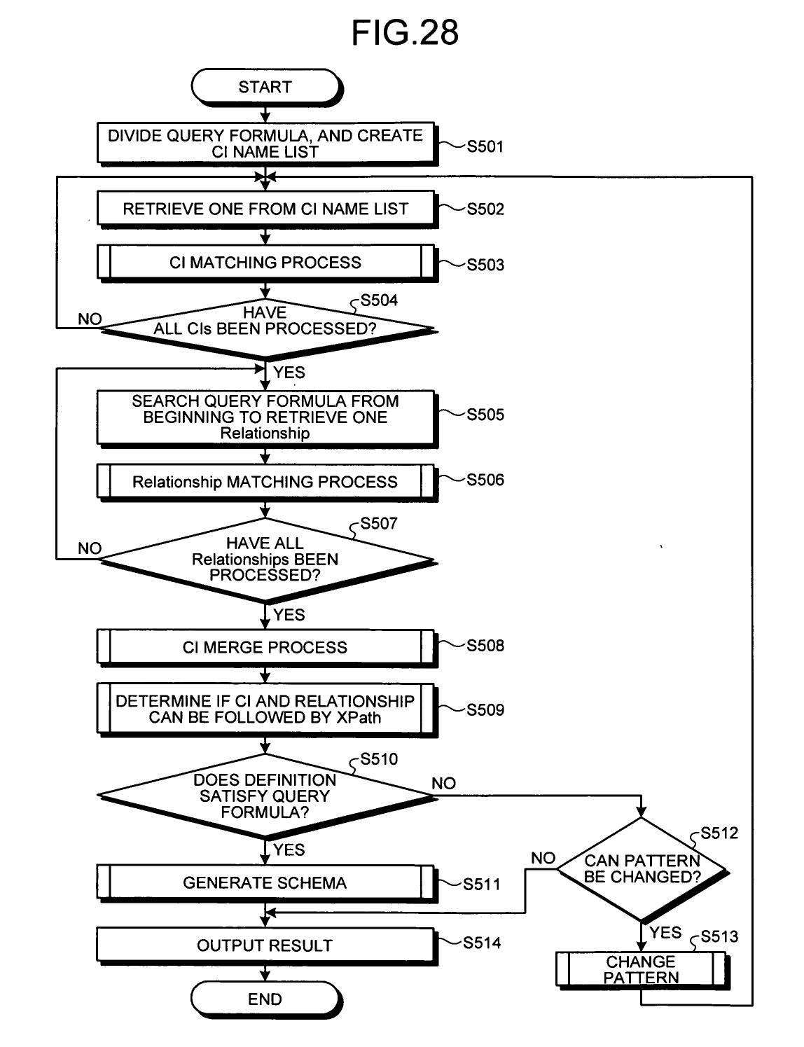

The operation of the schema generating device according to the third embodiment in its entire process will be described next by using FIGS. 28 to 31. The schema generating device according to the third embodiment differs from the schema generating device of the second embodiment of FIG. 13 in that, the schema generating device of the third embodiment additionally performs the CI merge process, the verification process, and a pattern changing process.

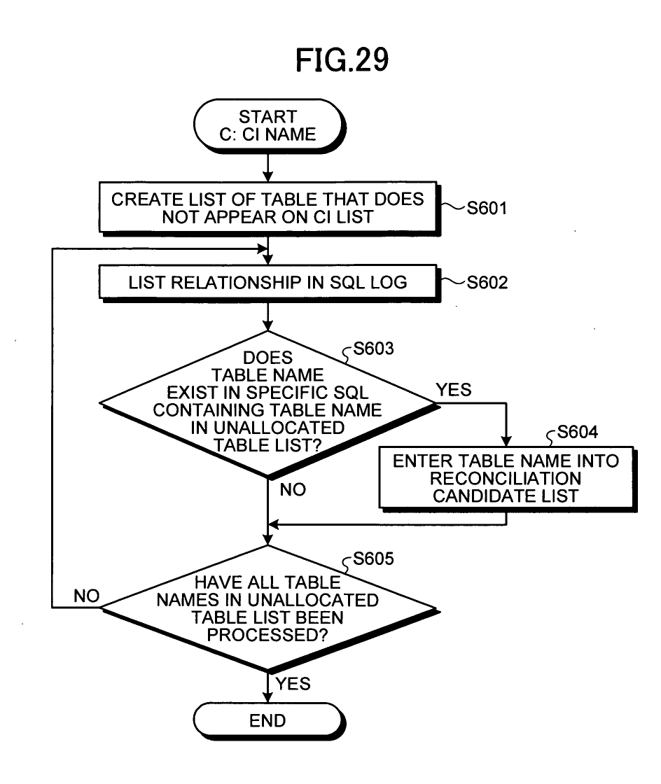

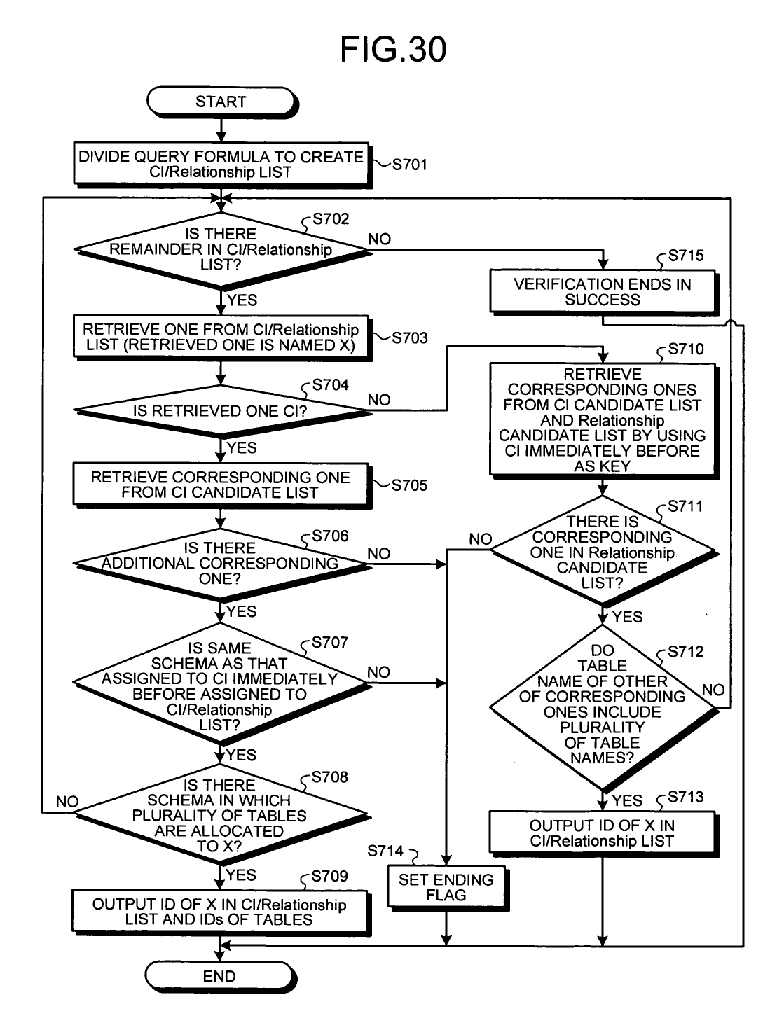

To be more specific, like in the second embodiment, the schema generating device 10A performs a matching process of all CIs (from step S501 to step S504), and performs a matching process of all Relationships (from step S505 to step S507) as illustrated in FIG. 28. Next, the schema generating device 10A according to the third embodiment performs the CI merge process (step S508) (described in detail later by using FIG. 29), and performs the verification process thereafter to determine if a CI and a Relationship can be followed by the Xpath (step S509) (described in detail later by using FIG. 30).

The schema generating device 10A determines as a result of the verification if a definition satisfies a query formula (step S510). If the definition satisfies the query formula (Yes in step S510), the schema generating device 10A performs a schema generating process like in the second embodiment (step S511), and outputs a generated schema definition as a result (step S514).

If the definition does not satisfy the query formula as a result of the verification (No in step S510), the schema generating device 10A determines if a pattern can be changed (step S512). More specifically, the schema generating device 10A determines that a pattern cannot be changed if a pattern has already been changed and all patterns have been processed, or if an ending flag is set.

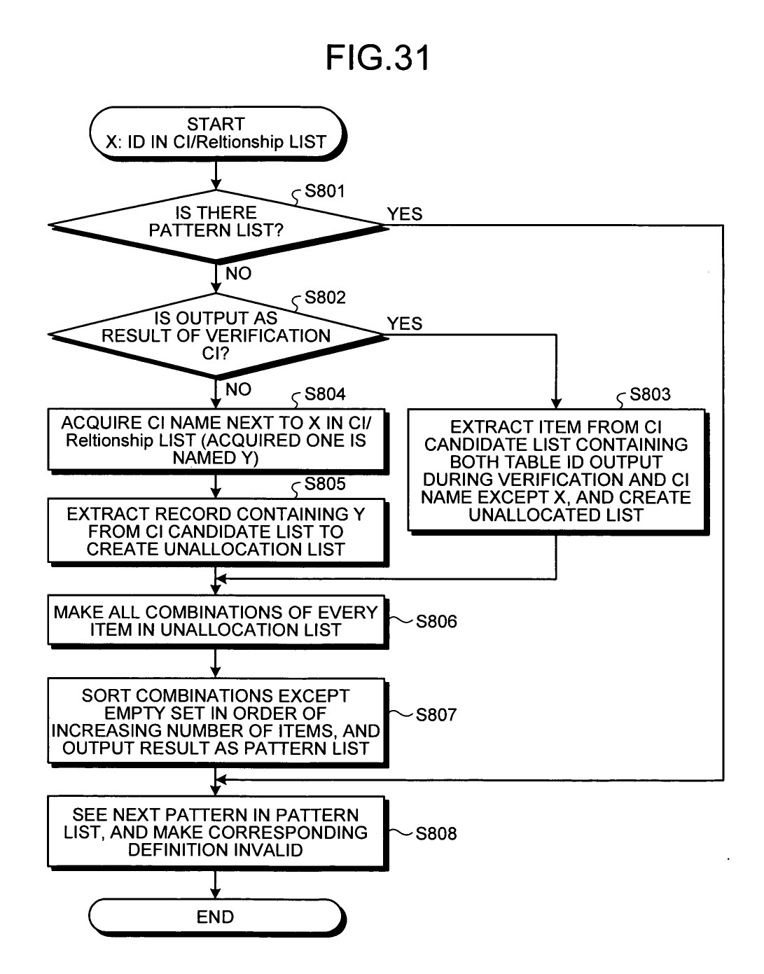

If a pattern can be changed (Yes in step S512), the schema generating device 10A performs the pattern changing process (step S513) (described in detail later by using FIG. 31). Next, the schema generating device 10A returns to step S502 to repeat the process. If a pattern cannot be changed (No in step S512), the schema generating device 10A outputs the result (step S514).

The CI merge process will be described next by using FIG. 29. FIG. 29 is a flow chart for explaining how the schema generating device according to the third embodiment operates in the CI merge process. As illustrated in FIG. 29, the schema generating device 10A creates the unallocated table list 11e including a table that does not appear on a CI list (step S601), and lists a Relationship contained in an SQL log (step S602). That is, the schema generating device 10A searches the SQL log for a specific SQL sentence containing a table name listed in the unallocated table list 11e.

Next, the schema generating device 10A determines if a table name exists in the specific SQL sentence containing the table name in the unallocated table list 11e (step S603). If there is a table name coinciding with that in a template (Yes in step S603), the schema generating device 10A enters this table name into the reconciliation candidate list 11f (step S604). If there is no table name coinciding with that in the template (No in step S603), the schema generating device 10A does not make entry into the reconciliation candidate list 11f, and proceeds to step S605.

The schema generating device 10A thereafter determines if all table names in the unallocated table list 11e have been processed (step S605). If all table names have not been processed (No in step S605), the schema generating device 10A returns to step S602 to repeat the process. If all table names in the unallocated table list 11e have been processed (Yes in step S605), the schema generating device 10A finishes the CI merge process.

The verification process will be described next by using FIG. 30. FIG. 30 is a flow chart for explaining how the schema generating device according to the third embodiment operates in the verification process. As illustrated in FIG. 30, the schema generating device 10A divides the query formula to create the CI/Relationship list 11g (step S701).

Next, the schema generating device 10A determines if there is a remainder in the CI/Relationship list 11g (step S702). If there is a remainder in the CI/Relationship list 11g (Yes in step S702), the schema generating device 10A retrieves one from the CI/Relationship list 11g (step S703). Then, the schema generating device 10A determines if what was retrieved is a CI (step S704). If what was retrieved is a CI (Yes in step S704), the schema generating device 10A retrieves a corresponding one from the CI candidate list 11c (step S705).

The schema generating device 10A thereafter determines if there is an additional corresponding one in the CI candidate list 11c (step S706). If there is an additional corresponding one (Yes in step S706), the schema generating device 10A determines if the same schema as that assigned to a CI immediately before is assigned to the CI/Relationship list 11g (step S707).

If the same schema as that assigned to a CI immediately before is assigned to the CI/Relationship list 11g (Yes in step S707), the schema generating device 10A determines if there is a schema in which a plurality of tables are allocated to the retrieved CI or Relationship (step S708).

If there is a schema in which a plurality of tables are allocated to the retrieved CI or Relationship (Yes in step S708), the schema generating device 10A outputs the IDs of the retrieved CI or Relationship and the IDs of these tables (step S709), and then finishes the verification process. If there is no schema in which a plurality of tables are allocated to the retrieved CI or Relationship (No in step S708), the schema generating device 10A returns to step S702.

If it is determined in step S706 that there is no additional corresponding one in the CI candidate list 11c (No in step S706), the schema generating device 10A sets an ending flag (step S714), and then finishes the verification process. If it is determined in step S707 that the same schema as that assigned to a CI immediately before is not assigned to the CI/Relationship list 11g (No in step S707), the schema generating device 10A sets an ending flag (step S714), and then finishes the verification process.

Turning back to step S704, if what was retrieved is not a CI (No in step S704), the schema generating device 10A retrieves corresponding ones from the CI candidate list 11c and the Relationship candidate list 11d by using a CI immediately before as a key (step S710). Next, the schema generating device 10A determines if there is a corresponding one in the Relationship candidate list 11d (step S711). If there is no corresponding one in the Relationship candidate list 11d (No in step S711), the schema generating device 10A sets an ending flag (step S714), and then finishes the verification process.

If there is a corresponding one in the Relationship candidate list 11d (Yes in step S711), the schema generating device 10A determines if the table name of the other of the corresponding ones include a plurality of table names (step S712). If the table name does not include a plurality of table names (No in step S712), the schema generating device 10A returns to step S702.

If the table name has a plurality of table names (Yes in step S712), the schema generating device 10A outputs the ID of the retrieved CI or Relationship in the CI/Relationship list 11g (step S713).

Turning back to step S702, if it is determined that there is no remainder in the CI/Relationship list 11g (No in step S702), the schema generating device 10A determines that the verification ends in success (step S715), and finishes the verification accordingly.

The pattern changing process will be described next by using FIG. 31. FIG. 31 is a flow chart for explaining how the schema generating device according to the third embodiment operates in the pattern changing process. As illustrated in FIG. 31, the schema generating device 10A determines if there is a pattern list (step S801). If there is a pattern list (Yes in step S801), the schema generating device 10A sees a next pattern in the pattern list, and makes a corresponding definition invalid (step S808).

If there is no pattern list (No in step S801), the schema generating device 10A determines if the output as a result of the verification is a CI (step S802). If the output as a result of the verification is a CI (Yes in step S802), the schema generating device 10A extracts an item from the CI candidate list 11c containing both a table ID output during the verification, and a CI name except for that listed in the CI/Relationship list 11g, and creates the unallocated CI list 11h (step S803).

If the output as a result of the verification is not a CI but a Relationship (No in step S802), the schema generating device 10A acquires a CI name next to the ID of the Relationship in the CI/Relationship list 11g (step S804).

Next, the schema generating device 10A extracts a record containing the acquired CI from the CI candidate list 11c to create an unallocation list (step S805). The schema generating device 10A thereafter makes all combinations of every item in the unallocation list (step S806), sorts the combinations except an empty set in order of increasing number of items, and outputs a result as the pattern list 11i (step S807). Next, the schema generating device 10A sees a next pattern in the pattern list 11i, and makes a corresponding definition invalid (step S808).

As described above, if tables contained in an SQL include an unallocated table not related to any CIs, the schema generating device 10A according to the third embodiment analyzes an SQL associated with the unallocated table, and assumes a CI with which the unallocated table is to be reconciled. This means that an SQL sentence associated with a remaining table left without having been related to any CIs is also used to generate a schema definition.

Further, the schema generating device 10A according to the third embodiment determines if a query formula can be traced by using the CI candidate list 11c and the Relationship candidate list 11d created. Thus, a schema definition of a higher degree of accuracy can be generated.

### [d] Fourth Embodiment

Other embodiments of the invention may be implemented in addition to the embodiments of the invention described above. A fourth embodiment as one of other embodiments of the invention will be described below.

(1) System Structure and Others

The constituting units in the devices illustrated in the drawings are functionally conceptual parts, and the physical structures thereof are not necessarily limited to those illustrated in the drawings. More specifically, the details of distribution and integration of the devices are not limited to those illustrated in the drawings. Part of or all of the devices may functionally and physically be distributed or integrated in any units according to various burdens, conditions of use and the like. As an example, the item analyzing unit 14 and the relationship analyzing unit 15 may be integrated.

(2) Program

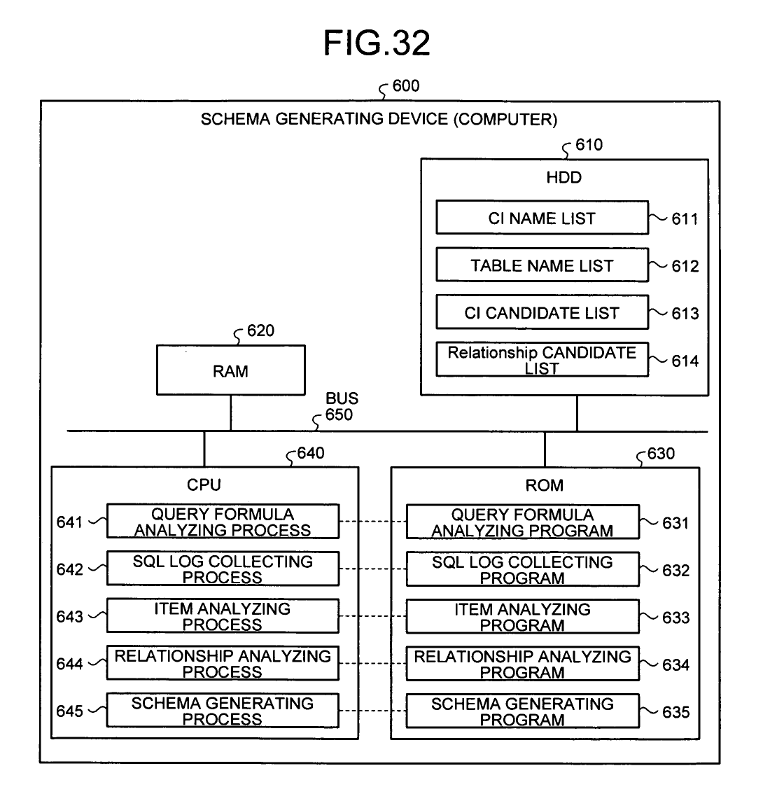

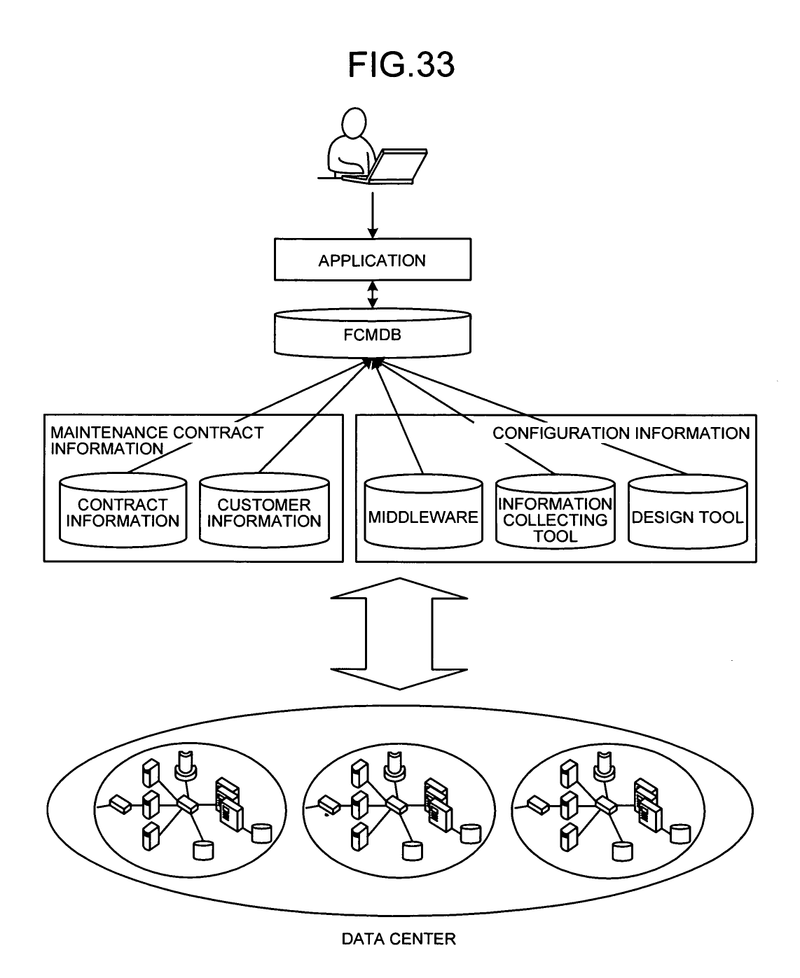

The foregoing processes described in the embodiments can be realized by causing a computer to execute a previously prepared program. In the below, an example of a computer that executes a program having the same functions as those in the aforementioned embodiments will be described by using FIG. 32. FIG. 32 illustrates a computer that executes a schema generating program.

As illustrated in FIG. 32, a computer 600 that executes the schema generating program includes a HDD 610, a RAM 620, a ROM 630, and a CPU 640, which are connected to each other through a bus 650.

Schema generating programs having the same functions as those of the aforementioned embodiments, more specifically a query formula analyzing program 631, an SQL log collecting program 632, an item analyzing program 633, a relationship analyzing program 634, and a schema generating program 635 are stored in advance in the ROM 630 as illustrated in FIG. 32. Like the constituting units of the schema generating device illustrated in FIG. 2, the programs 631 to 635 may be integrated or distributed, where appropriate.

The CPU 640 reads the programs 631 to 635 from the ROM 630 and executes the read programs, by which the programs 631 to 635 become operative to realize a query formula analyzing process 641, an SQL log collecting process 642, an item analyzing process 643, a relationship analyzing process 644, and a schema generating process 645, respectively.

As illustrated in FIG. 32, the HDD 610 stores a CI name list 611, a table name list 612, a CI candidate list 613, and a Relationship candidate list 614. The CPU 640 enters data into the CI name list 611, the table name list 612, the CI candidate list 613, and the Relationship candidate list 614. The CPU 640 also reads data from the CI name list 611, the table name list 612, the CI candidate list 613, and the Relationship candidate list 614, stores the read data into the RAM 620, and performs a process based on the data stored in the RAM 620.

A schema definition is generated automatically. Thus, the number of man-hours required for generating a schema definition is reduced, so that a schema definition can be generated promptly.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention

What is claimed is:

1. A schema definition generating device comprising:
an item comparison generating unit that compares configuration item information and table information, and generates correspondence information indicating a correspondence between the configuration item information and the table information, the configuration item information being contained in a query formula used to search for configuration item information indicating a configuration item targeted for management, the table information being contained in history information of queries made to a relational database;
a relationship comparison generating unit that compares relational information and information indicating a relationship between tables contained in the query history information, and generates correspondence information indicating a correspondence between the relational information and the query history information, the relational information indicating a relationship between configuration items contained in the query formula; and
a schema definition generating unit that generates a schema definition of the configuration item information and a schema definition of the relational information by using the correspondence information generated by the item comparison generating unit, and the correspondence information generated by the relationship comparison generating unit.

2. The schema definition generating device according to claim 1, wherein the item comparison generating unit compares a name of the configuration item information in the query formula and a name of the table information in the query history information, and defines the name of the configuration item information and the name of the table information in a set as the correspondence information if the name of the configuration item information and the name of the table information coincide with each other.

3. The schema definition generating device according to claim 1, further comprising a subordinate item assuming unit that, if the table information compared by the item comparison generating unit includes unallocated table information not related to any configuration item information, analyzes query history information associated with the unallocated table information, and assumes configuration item information subordinate to the unallocated table information.

4. The schema definition generating device according to claim 1, further comprising a verifying unit that determines if the query formula can be traced by using the correspondence information generated by the item comparison generating unit and the correspondence information generated by the relationship comparison generating unit.

5. A schema definition generating method comprising:
comparing configuration item information and table information to generate correspondence information indicating a correspondence between the configuration item information and the table information, the configuration item information being contained in a query formula used to search for configuration item information indicating a configuration item targeted for management, the table information being contained in history information of queries made to a relational database;
comparing relational information and information indicating a relationship between tables contained in the query history information to generate correspondence information indicating a correspondence between the relational information and the query history information, the relational information indicating a relationship between configuration items contained in the query formula; and
generating a schema definition of the configuration item information and a schema definition of the relational information by using the generated correspondence information indicating a correspondence between the configuration item information and the table information, and the generated correspondence information indicating a correspondence between the relational information and the query history information.

6. A computer-readable, non-transitory medium storing a schema definition generating program causing a computer to execute a process, the process comprising:
comparing configuration item information and table information to generate correspondence information indicating a correspondence between the configuration item information and the table information, the configuration item information being contained in a query formula used to search for configuration item information indicating a configuration item targeted for management, the table information being contained in history information of queries made to a relational database;
comparing relational information and information indicating a relationship between tables contained in the query history information to generate correspondence information indicating a correspondence between the relational information and the query history information, the relational information indicating a relationship between configuration items contained in the query formula; and
generating a schema definition of the configuration item information and a schema definition of the relational information by using the generated correspondence information indicating a correspondence between the configuration item information and the table information, and the generated correspondence information indicating a correspondence between the relational information and the query history information.

7. A schema definition generating device comprising:
a processor coupled to a memory,
wherein the processor is configured to
compare configuration item information and table information to generate correspondence information indicating a correspondence between the configuration item information and the table information, the configuration item information being contained in a query formula used to search for configuration item information indicating a configuration item targeted for management, the table information being contained in history information of queries made to a relational database;
compare relational information and information indicating a relationship between tables contained in the query history information to generate correspondence information indicating a correspondence between the relational information and the query history information, the relational information indicating a relationship between configuration items contained in the query formula; and
generate a schema definition of the configuration item information and a schema definition of the relational information by using the generated correspondence information indicating a correspondence between the configuration item information and the table information, and the generated correspondence information indicating a correspondence between the relational information and the query history information.
